(19) United States
(12) Patent Application Publication
(10) Pub. No.: US 2026/0225882 A1
(43) Pub. Date: Aug. 6, 2026

(54) SYSTEMS AND METHODS FOR CONVERTING HYDROCARBONS TO HYDROGEN WITH USEFUL CARBON BY-PRODUCTS

(71) Applicant: UNIVERSITY OF LOUISVILLE RESEARCH FOUNDATION, INC., Louisville, KY (US)

(72) Inventors: Mahendra SUNKARA, Louisville, KY (US); William Mark MCGINLEY, Louisville, KY (US); Gautam GUPTA, Louisville, KY (US); Abhinav NOUDURI, Louisville, KY (US); Bikram BHATIA, Louisville, KY (US)

(73) Assignee: UNIVERSITY OF LOUISVILLE RESEARCH FOUNDATION, INC., Louisville, KY (US)

(21) Appl. No.: 19/149,871

(22) PCT Filed: Feb. 13, 2024
(86) PCT No.: PCT/US2024/015488

§ 371 Date: Jul. 22, 2025

Related U.S. Application Data
(60) Provisional application No. 63/445,425, filed on Feb. 14, 2023.

(51) Int. Cl. C01B 3/26; C01B 32/205

(52) U.S. Cl. CPC C01B 3/26; C01B 32/205; C01B 2203/0277; C01B 2203/0861; C01B 2203/1041; C01B 2203/1241

(57) ABSTRACT

Systems and methods for the production of hydrogen are provided. The methods include activating hydrocarbons to produce methyl cations and hydrogen anions in a gas phase; forming hydrogen from the hydrogen anions in the gas phase; and forming carbon species from the methyl cations in the gas phase, wherein forming hydrogen and carbon species is performed in a presence of a molten metal or molten metal alloy. An integrated device for producing hydrogen is also provided.

### CROSS REFERENCE TO RELATED APPLICATIONS

This application claims the benefit of U.S. Provisional Patent Application Ser. No. 63/445,425 filed on Feb. 14, 2023, and incorporates said provisional application by reference into this document as if fully set out at this point.

### FIELD OF THE INVENTION

The invention generally relates to methods for producing clean hydrogen from hydrocarbons such as methane with valuable carbons as by-products. In particular, the methods include pyrolysis of hydrocarbons while hydrogen and carbon species are formed in the presence of a molten metal or molten metal alloy.

### BACKGROUND OF THE INVENTION

Hydrogen can be produced from various feedstocks sources like natural gas, oil, coal, water electrolysis, and biomass [1]. Currently, hydrogen is produced from steam reforming of methane [2]. This process is performed at higher temperature (700-900° C.) with 70-85% efficiency in the presence of catalysts and results in the emission of carbon dioxide at >9 tons/ton of hydrogen produced with costs of $1.0-1.2/kg of H₂. This process is practiced by refineries, chemical processing units and also fuel cell power plants for producing hydrogen for hydro-processing (cracking and desulfurization of fuels from crude); ammonia and methanol production, etc [3].

In the US alone, there is a need for more than 10 million tons/year of hydrogen production. Solar powered electrolyzer is an option for producing clean hydrogen. However, the current costs for hydrogen using solar+PV technology exceed $4/kg. Even with the best electrolyzer technology, the energy requirement for 1 Kg of hydrogen is more than 50 kWh. Even if the power is derived from renewable sources, the associated CO₂ emissions can be as large as 2 Kg CO₂ per Kg of hydrogen (based on 40 grams of CO₂ per kWh of solar power).

Thermodynamically speaking, to produce 1 mole of hydrogen using methane pyrolysis requires only 37.5 kJ, compared to 286 kJ for one mole of hydrogen from water electrolysis. [4] Methane pyrolysis has the potential to become the source of clean hydrogen and significantly reduce global CO₂ emissions. According to US Energy Information Administration, the cost of natural gas is currently about $10/(1000 cu·ft), which translates to about $2.5-3/Kg for the hydrogen contained in the natural gas. Unless there is a value for carbon or any other byproduct from pyrolysis, the resulting hydrogen will be too expensive for the marketplace.

Direct methane production would result in reduced carbon dioxide emissions. However, direct methane pyrolysis is only possible at temperatures around 1500-2000° C. Such temperatures are not feasible through renewable energy sources without having a large solar concentrator. On the other hand, methane can be pyrolyzed with high yields at moderate temperatures on supported or molten metal catalysts (Ni, Co, Fe, Pt, Pd); however, catalysts are rapidly deactivated by solid carbon. The energy value of resulting hydrogen will be half that of methane. The cost of hydrogen would easily exceed $4/Kg if the resulting carbon products are not used as byproducts.

State of the art catalytic processes are generally performed at higher temperatures. This results in the irreversible coking of the catalysts that keeps them from being recycled. In addition, most commercial processes utilize specialized (x property) catalysts which results in high costs of H₂ production. Finally, none of the current processes allow ease of removal/recovery of carbon from the catalyst supports resulting in increased hydrogen production costs.

It is possible to create various carbon structures with the use of catalysts at atmospheric pressure. However, the use of nanoclusters of transition metals such as nickel, iron, platinum etc., can be expensive and also contaminates the resulting carbon structures. Recently, McFarland and his colleagues have focused on a bubbling packed bed reactor using molten metals [6] and molten salts [7, 8] as catalysts to separate resulting carbon and hydrogen. However, the temperatures used were in excess of 1000° C. This process is limited due to slow kinetics, high temperatures and potential shut down of the reaction over time.

Another way to deposit carbon using methane is using catalytic chemical vapor deposition schemes to pyrolyze methane and produce hydrogen. Catalytic chemical vapor deposition (CVD) has become the most common method for growing carbon nanotubes (CNTs) due to its versatility and scope for scale-up in production [9]. Using this method, both single-walled nanotubes (SWNTs) [10] and multi-walled nanotubes (MWNTs) [11] can be synthesized using a transition metal catalyst (Ni, Co, Fe etc.) and a carbon feedstock (methane, ethylene, acetylene etc.). These approaches suffer from the following problems for scalable production of hydrogen. Due to their fine particle nature, these catalysts need to be provided supports and used in a packed bed fashion. This makes it difficult to separate the resulting carbon structures and re-use of the catalyst.

Thus, new methods for producing hydrogen at scale with useful carbon by-products are needed.

### SUMMARY

The present disclosure describes scalable hydrogen production using pyrolysis of hydrocarbons while producing contamination free carbon and reducing carbon dioxide emissions. The methods involve activating hydrocarbons and pyrolyzing using molten metals or alloys thereof such as gallium. The systems and methods for direct hydrocarbon pyrolysis can reduce carbon dioxide footprint and costs to less than $1/kg as the carbon by-product has a value in excess of $3/kg.

An aspect of the disclosure provides a method for producing hydrogen, comprising activating a hydrocarbon to produce methyl cations and hydrogen anions in a gas phase; forming hydrogen from the hydrogen anions in the gas phase; and forming carbon species from the methyl cations in the gas phase, wherein forming hydrogen and carbon species is performed in a presence of a molten metal or molten metal alloy. In some embodiments, the hydrocarbon is selected from the group consisting of methane, acetylene, and propane. In some embodiments, the molten metal is selected from gallium, indium, tin, aluminum, and bismuth. In some embodiments, forming hydrogen and carbon species is performed at less than 900° C. In some embodiments, the alloy comprises one or more of iron, nickel, molybdenum, cobalt, ruthenium, platinum, iridium, and rhenium. In some embodiments, the carbon species is a graphitic carbon.

In some embodiments, activating is performed by thermo-catalytic activation. In some embodiments, the thermo-catalytic activation comprises carburizing one or more filaments comprised of tungsten, rhenium, iron, or nickel or alloys thereof with the hydrocarbon; producing the methyl cations and hydrogen anions from the one or more filaments; and interacting the methyl cations and hydrogen anions with a surface of the molten metal or molten metal alloy, wherein the molten metal is gallium. In some embodiments, the method further comprises periodically removing carbon species formed on the surface.

In some embodiments, activating is performed by a plasma catalytic activation. In some embodiments, the plasma catalytic activation comprises forming a plasma containing electrons, wherein the electrons collide with the hydrocarbon to produce the methyl cations and the hydrogen anions; and passing droplets or particles of the molten metal or molten metal alloy through the plasma, wherein the molten metal is gallium.

Another aspect of the disclosure provides an integrated device for production of hydrogen, comprising a hydrocarbon inlet; an excitation source configured to heat the hydrocarbon flowing in the hydrocarbon inlet to produce methyl cations and hydrogen anions; a reservoir for containing a molten metal or molten metal alloy, wherein the reservoir is positioned adjacent the excitation source such that hydrogen is formed from the hydrogen anions and carbon species is formed from the methyl cations while in a gas phase adjacent a surface of the molten metal or molten metal alloy; a collection space for collecting the carbon species; and an outlet for collecting the hydrogen. In some embodiments, the excitation source is a filament grid or a plasma containing electrons.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE DRAWINGS

FIG. 1. A schematic illustrating methane pyrolysis using hot-filament activated thermos-catalytic reaction between hydrocarbons and atomic hydrogen on molten Ga or its alloys.

FIGS. 2A-B. (A) Atmospheric microwave plasma discharge contained downstream in a quartz tube and (B) Atmospheric microwave plasma discharge that can be contained in an upward fashion in a chamber with separation of flame from walls.

FIGS. 3A-B. (A) SEM and (B) TEM images of carbons produced from thermo-catalytic methane pyrolysis.

FIGS. 4A-B. (A) Schematic of filament grid along with substrate holder to contain Ga pool and (B) alternative design of integrated unit.

FIGS. 5A-B. (A) Schematic of an integrated unit complete with separation and recycle. (B) Schematic illustrating the design of a reactor with multiple filament grids.

FIG. 6. Photograph of a hot-filament setup where the flow is from one end to the other end.

FIG. 7. Schematic of an exemplary plasma catalytic approach for methane pyrolysis using Gallium and its alloys for hydrogen and carbon microtube production.

FIG. 8. Exemplary reactor setup.

FIG. 9. Exemplary reactor setup.

FIG. 10. Ga boat before and after reaction showing carbon deposition and the reactor covered with deposition after reaction.

FIG. 11. XRD data of commercial carbon black and carbons collected from the wall, on Ga, and on the filament.

FIGS. 12A-B. Carbon deposited A) on the walls after reaction and B) on the Ga in boats after reaction.

FIG. 13. XRD data of commercial carbon black and carbons collected from the wall, on Ga and on the filament.

FIGS. 14A-B. SEM images of carbon A) collected on the catalyst Ga and B) collected from the walls.

FIG. 15. Elemental analysis using EDX.

FIGS. 16A-B. A) Reaction without any Ga. B) Wax deposition at the end of the reactor after the run without Ga.

FIGS. 17A-C. SEM images of A, B) carbon collected on the walls and c) W filament after the reaction.

FIG. 18. XRD data of carbons collected from the wall, on Ga for Example 4 and carbon from the walls in Example 5.

FIGS. 19A-C. A) Schematic of the MW reactor setup used for the pyrolysis experiments, B) Plasma during the run, and C) Ga with carbon growth after the reaction.

FIG. 20. Methane conversion and carbon yield with and without Gallium, Gallium and tin powder and Gallium and Nickel powder.

FIGS. 21A-D. SEM and TEM images of Carbon collected with (A,B) and without (C,D) Ga on the substrate after the reaction.

FIGS. 22A-C. SEM images of Carbon collected from Ga (A,B) and Sn (C) after the reacting using Ga—Sn as catalyst.

FIGS. 23A-C. SEM images of carbon collected after the reaction using Ga—Ni as catalyst.

FIG. 24. XRD of carbon on Gallium and tin powder and Gallium and Nickel powder.

### DETAILED DESCRIPTION

Described herein are methods, systems, and devices for activating and pyrolyzing hydrocarbons to produce hydrogen and carbon as a byproduct. Embodiments provide selective pyrolysis on molten elements, such as gallium (Ga), and easy separability from the molten elements. The reactor schemes can be modular, easily scalable, and energy efficient. The present disclosure enables decarbonization of hydrocarbons and also production of low-cost, clean hydrogen for use in transportation, power generation for micro-grids and for many industrial processes. The availability of low cost, clean hydrogen using a variety of hydrocarbon sources enables economic revitalization of fossil distressed and rural communities.

Embodiments of the disclosure utilize hydrocarbon activation, e.g. using either hot-filaments or plasmas, and then selective pyrolysis using low-melt temperature metals, or their alloys. Such a method for producing hydrogen may comprise steps of i) activating a hydrocarbon to produce methyl cations and hydrogen anions in a gas phase; ii) forming hydrogen from the hydrogen anions in the gas phase; and iii) forming carbon species from the methyl cations in the gas phase, wherein forming hydrogen and carbon species is performed in a presence of a molten metal or molten metal alloy. Generally, a molten or liquid metal solution (generally at least 99% purified, such as 99.5, 99.6, 99.7, 99.8 or 99.9% purified) is used.

Embodiments of the disclosure preferably utilize low melting metals or alloys thereof which do not form carbides and have a low solubility for carbon. Thus, the low melting metals or alloys thereof enable surface segregation of the carbons which enables easier separation. The metals or metal alloys used herein may have melting temperatures at or below 1000° C., e.g. at or below 900° C. or 800° C. The reactions as described herein are conducted at a temperature such that the metal or alloy thereof is in a molten state. Periodic scraping using either mechanical knife or air knife keeps the fresh molten metal or metal alloys exposed to excited hydrocarbons. Exemplary metals may include Group III elements which comprise two subgroups: group IIIa and group IIIb. Group IIIa comprises scandium, yttrium, and lanthanium, which is generally considered with the lanthanoids, and actinium, which is classified with the actinoids. Group IIIb, the main group, comprises boron, aluminum, gallium, indium, and thallium. Other low melting metals include tin and bismuth. Of all of these elements, Ga has the lowest vapor pressure over the temperature range between 30-900° C., making it highly suitable for various processing applications. However, these metals are not catalytic and do not react directly with methane and/or hydrogen. When activated, methane and hydrogen become excited molecules and produce radical species which can interact with molten metals. Alloys with additional transition metals such as iron, nickel, molybdenum, cobalt, and/or with precious metals such as ruthenium, platinum, iridium, rhenium etc. are more catalytic at higher temperatures. In some embodiments, the alloy contains other low melting metals such as indium, tin, copper, and aluminum. A combination of hydrocarbon activation and alloys of low-melting metals with catalytic elements reduces the temperature required for hydrocarbon pyrolysis while allowing for easier separation of carbon. In some embodiments, forming hydrogen and carbon species is performed at less than 900° C., e.g. 30-900° C. or 30-850°.

Any type of hydrocarbon may be used in a method or device as described herein. Hydrocarbons are organic compounds consisting of hydrogen and carbon. Suitable hydrocarbons include, but are not limited to, methane, acetylene, propane and other aromatics such as benzene, toluene, etc. Other hydrocarbons could also include methanol, ethanol and acetone, etc.

The following describes the mechanism for methane pyrolysis using activation of methane followed by interaction with molten Ga alloys.

$$Methane activation : {CH}_{4} ⇒ {CH}_{3} + H$$

$$Gas phase : {C}_{3} + {CH}_{3} + M ⇒ {C}_{2} {H}_{6} + M$$

$$H + H + M ⇒ {H}_{2} + M$$

$$Ga surface : {CH}_{x} + H ⇒ C + ( x + 1 ) / 2 {H}_{2}$$

Embodiments of the disclosure include two reactor schemes for activating hydrocarbons: thermo-catalytic approach and plasma catalytic approach. The reactors implementing the aforementioned approaches can be implemented at various scales.

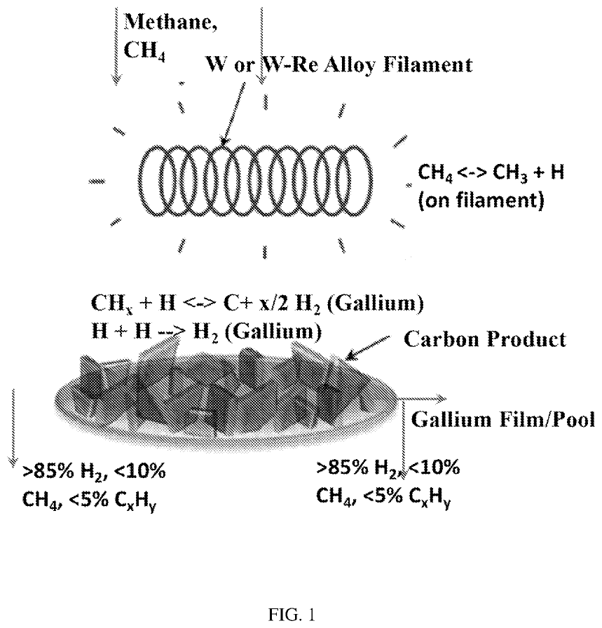

The thermo-catalytic approach for activating hydrocarbons is based on hot-filaments for activation of hydrocarbon and providing the necessary thermal input for substrate toward hydrocarbon pyrolysis. The hot-filaments are made using tungsten, rhenium, iron, or nickel, or alloys thereof, such as molybdenum alloys. The filaments are first carburized using pure hydrocarbon at a certain temperature (e.g. 1800° C. or higher) for a certain period of time. Once carburized, the filaments can be sustained for a long period of time with the presence of hydrocarbon and hydrogen in the system. The filaments may be organized as a grid and positioned directly above the substrate. The substrate may be covered with a thick film or pool of liquid metals or their alloys. As shown in FIG. 1, methane interacts at hot-filaments and undergoes the first pyrolysis reaction by producing methyl radicals and atomic hydrogen. These CHx and H radicals further interact with molten Ga and its alloys and undergo subsequent hydrogen abstraction reactions to produce carbon. CHₓ radicals can further react with each other and form C₂Hₓ species as well, which also can undergo further pyrolysis reaction and participate in the carbon growth. Activated radicals and atomic hydrogen react with molten Ga and its alloys and diffuse inside molten Ga. Under such exposure, there will be a high concentration of hydrogen inside molten Ga leading to increased pyrolysis reactions. Molten Ga exhibits a non-wetting surface with the resulting carbons and also exhibits low solubility for carbon. The resulting carbons grow on the surface with no, or little adhesion with Ga surface. The resulting carbons can easily be mechanically removed, e.g. by physical blading and/or by air knife. Periodic removal of resulting carbons will ensure that a fresh molten Ga surface is exposed to hydrocarbon and atomic hydrogen radicals. Molten Ga interacts with atomic hydrogen and CHx species at temperatures as low as 100° C. as with dissolution of excited species and radicals thereby enabling pyrolysis at low temperatures and achieving high energy efficiency.

Embodiments provide an integrated unit for scalable production of clean hydrogen and valuable carbons (FIGS. 4A-B). In this device, hydrocarbons are introduced through the excitation or activation source (e.g. a filament grid) and the resulting activated gas phase interacts with a molten metal pool below. The distance between the excitation source and the substrate and pressure dictates substrate temperature and atomic hydrogen concentration. The process may be conducted at various pressures ranging from sub-atmospheric to high pressures, e.g. from 0.01 to 10 atmospheres. In some embodiments, the integrated device comprises a hydrocarbon inlet; an excitation or activation source configured to heat the hydrocarbon flowing in the hydrocarbon inlet to produce methyl cations and hydrogen anions; a reservoir for containing a molten metal or molten metal alloy, wherein the reservoir is positioned adjacent the excitation source such that hydrogen is formed from the hydrogen anions and carbon species is formed from the methyl cations while in a gas phase adjacent a surface of the molten metal or molten metal alloy; a collection space for collecting the carbon species; and an outlet for collecting the hydrogen.

FIGS. 5A-B show a simple schematic illustrating scale-up. The use of smaller size filament grids may reduce sagging of filaments with time and the use of multiple grids may also enable redundancy with source activation during failure of any one of the filament grids. The integrated unit may contain components such as a hydrogen separator, one or more pumps, measurement devices, and a hydrogen flare for safe disposal of the hydrogen produced.

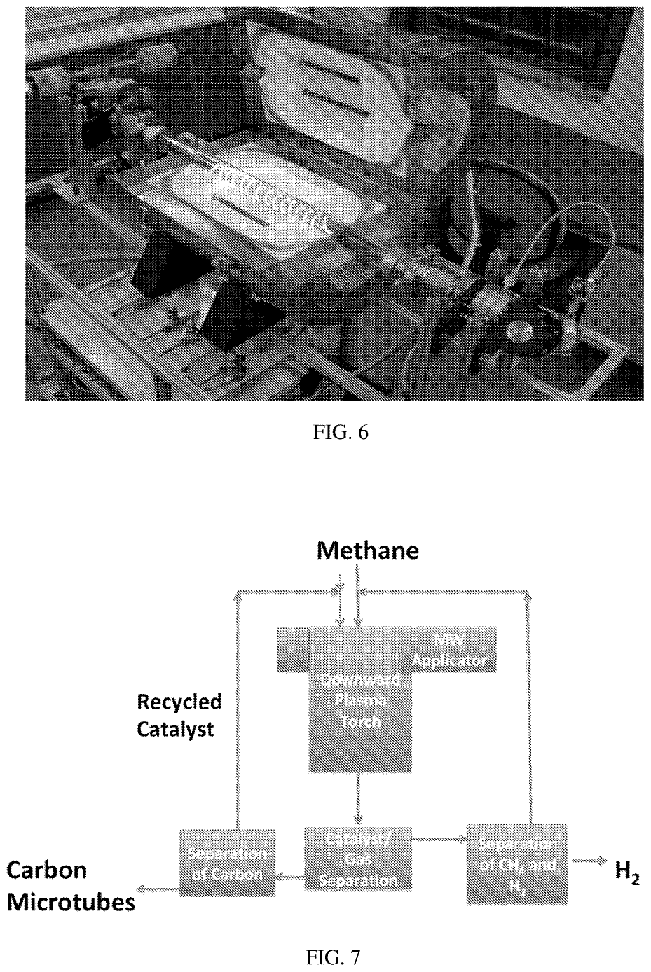

Conditions that may be optimized to improve pyrolysis efficiency per pass and lowering energy input while increasing throughput include variables such as filament temperature, pressure, hydrocarbon flow rates, molten element film exposure, filament grid radius vs substrate, flow geometry, etc. Reactors with different geometries for gas flow and filament designs may be used. One example of a hot-filament reactor is shown in FIG. 6.

Conditions that may be varied to optimize carbon yield include filament temperature, pressure, distance between filament and underlying molten element substrate, and the flow direction. The pyrolysis efficiency may be estimated as percentage of hydrocarbon resulting in complete pyrolysis, e.g., CH₄(g)=>C(s)+H₂. The process preferably achieves >80% pyrolysis yield per pass and >95% with recycling.

In some embodiments, the filaments are run at lower temperatures (e.g. 300-2000° C.) for longevity and energy efficiency. Preferably, the projected energy consumption should not exceed 50 kWh per Kg of hydrogen. This translates to a throughput of 4 lpm-H₂/kW.

The resulting solid sample may be heated under inert atmosphere to allow for the metal to separate from carbons. After that, the sample will either be subjected to centrifuging or to mechanical shaking to separate carbon structures from molten metal alloys thereof. The recovered molten metal or alloys thereof may be recycled and re-used.

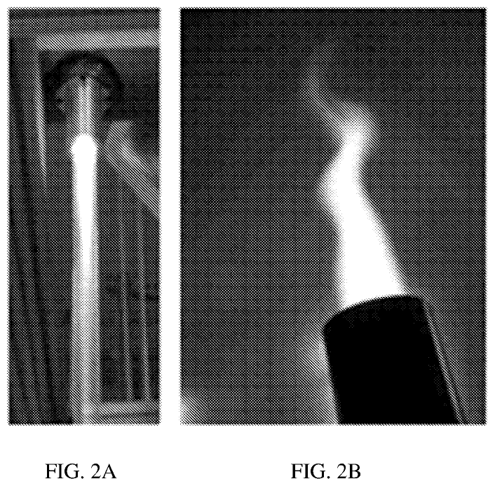

The plasma catalytic approach for activating hydrocarbons may utilize electric power by creating plasma discharges in which highly energetic electrons collide with the hydrocarbon to activate it by producing a radical soup consisting of CHx and H species. Plasmas can be created using a variety of reactor designs and different types of electric power (direct, low-frequency, radio-frequency, and microwaves etc.). In some embodiments, a 2 kW microwave plasma reactor with flame extending 2 feet or more may be utilized as shown in FIG. 2A. In this approach, micro-sized molten metal (or alloys thereof) droplets will be dropped into plasma flame and collected at the bottom along with carbon deposition. In some embodiments, some carbons are collected from the gas phase through separation from metal particles. In some embodiments, fine powders of the molten metal or molten metal alloy are produced and are fluidized through an upward facing flame as shown in FIG. 2B. Alloys with other low-melting elements (e.g. In, Sn, Al) allow for solid fine powders at room temperature for easy fluidization when using both downward and upward flame configurations. In the case of alloys with other catalytic metals such as Ni and Fe, one may observe faster kinetics and different carbon morphologies such as single walled nanotubes etc.

In one embodiment of the plasma catalytic approach, an atmospheric plasma torch is oriented downward while introducing low-melt metal or alloy powder using a gravity-fed device. This powder is collected at the bottom of the tube (FIG. 7). The solids including carbon may be sent to a centrifuge to separate the carbons. The low-melting metal powders are then sent in a recycling loop to the top of the system. The resulting hydrogen rich hydrocarbon stream is separated using either a membrane or a PSA unit. The un-pyrolyzed hydrocarbons are recycled to the plasma torch. In some embodiments, the plasma torch is oriented upward with low melt metal or alloy powders being fluidized while the resulting carbons containing metal are entrained and collected in either a cyclone or a baghouse filter. The resulting gases are subjected to separation of hydrogen, sending un-reacted hydrocarbons back to the plasma torch.

The carbon products produced using hydrocarbon pyrolysis can occur in a variety of 0-D, 1-D, 2-D and 3-D structures, depending upon the type and form of catalysts used. Example products include, but are not limited to, single walled nanotubes, multi-walled nanotubes, micro-tubes with nanocrystalline graphitic walls, carbon onions, nanoscale fibers, etc. In some embodiments, the carbon product is a graphitic carbon. These products, depending upon both microscopic and macroscopic structures, will find different applications ranging from adsorbents, conducting carbons, capacitors, batteries and catalyst supports, and carbon-carbon composites, among many others. In some embodiments, the resulting carbons are functionalized for end applications, e.g. with platinum for fuel cell and hydrogenation applications. The high surface area, nanoscale carbons lend themselves toward integration as anode applications.

While the present invention has been illustrated by the description of embodiments thereof and specific examples, and while the embodiments have been described in considerable detail, it is not intended to restrict or in any way limit the scope of the appended claims to such detail. Additional advantages and modifications will readily appear to those skilled in the art. Thus, the invention in its broader aspects is therefore not limited to the specific details, representative apparatus and methods and illustrative examples shown and described. Accordingly, departures may be made from such details without departing from the scope or spirit of applicant's general inventive concept.

It is to be understood that this invention is not limited to particular embodiments described herein above and below, and as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. at which the cell reaction takes place

The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1. Thermo-Catalytic Methane Pyrolysis

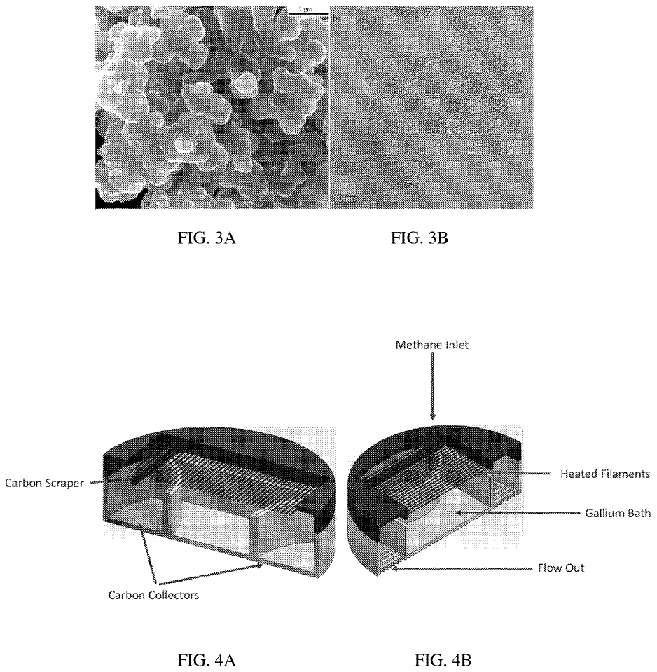

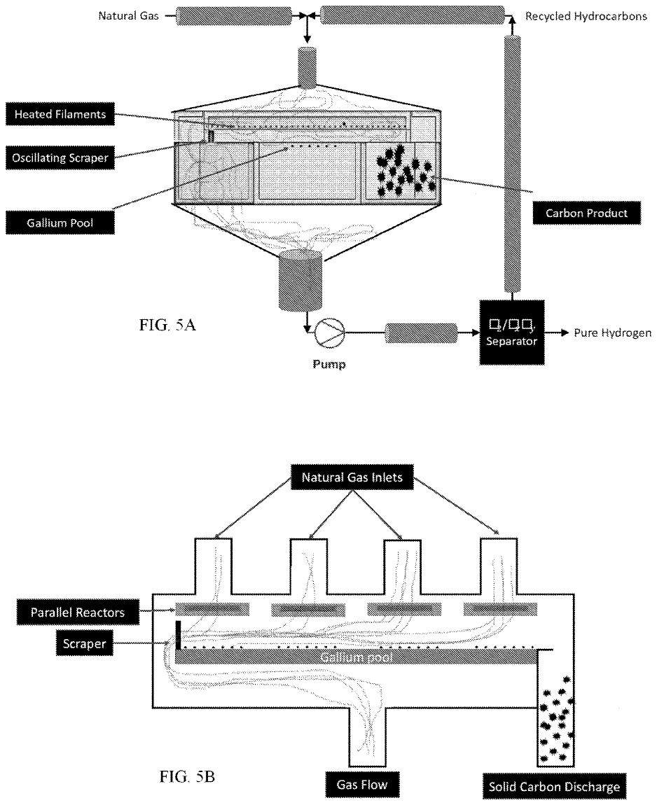

Experimental results at low pressures (<0.1 atm) using activated hydrocarbon gas phase and a molten Ga pool are shown below in Table 1. The results with acetylene indicate higher pyrolysis rates with the majority getting converted to carbon and hydrogen. Several experiments using methane indicate production of small amounts of C₂Hₓ species and hydrogen with pyrolysis fraction >50-60%. The resulting carbon and hydrogen balance are within +−20%. The lower amount of carbon recovered compared to that expected represents only that recovered from the top of the Ga surface. Other parts of the reactor could have had trace amounts of Ga that were not accessed. Table 1 shows that the disclosed technology has been well demonstrated at lab scale and can be optimized for improved energy and pyrolysis efficiency. Most importantly, the experiments demonstrate easily and complete separability of carbon from molten Ga. It is thus easy to recover the Ga from the carbon and re-use it. The recovered carbons were analyzed using electron microscopy and they indicate onion ring type nanoscale structures as shown in FIG. 3.

TABLE 1
Decarbonization experiments using methane and acetylene on molten
Gallium for hydrogen production and carbon yields (1 hour run).

| | | | Methane | Acetylene | H₂ outlet | Recovered |
|---|---|---|---|---|---|---|
| | Inlet Flow | Outlet Flow | outlet flow | outlet flow | flow | Carbon |
| Gas | (SCCM) | (SCCM) | (SCCM) | (SSCM) | (SCCM) | (mg) |
| Acetylene | 50 | 58.8 | NA | 2.1 | 56.7 | 1932 |
| Methane | 100 | 150-176.8 | 13.7 | 11.2-30 | 110-142 | 900-1240 |

### Example 2. Thermo-Catalytic Methane Pyrolysis Using Hot Filament Reactor

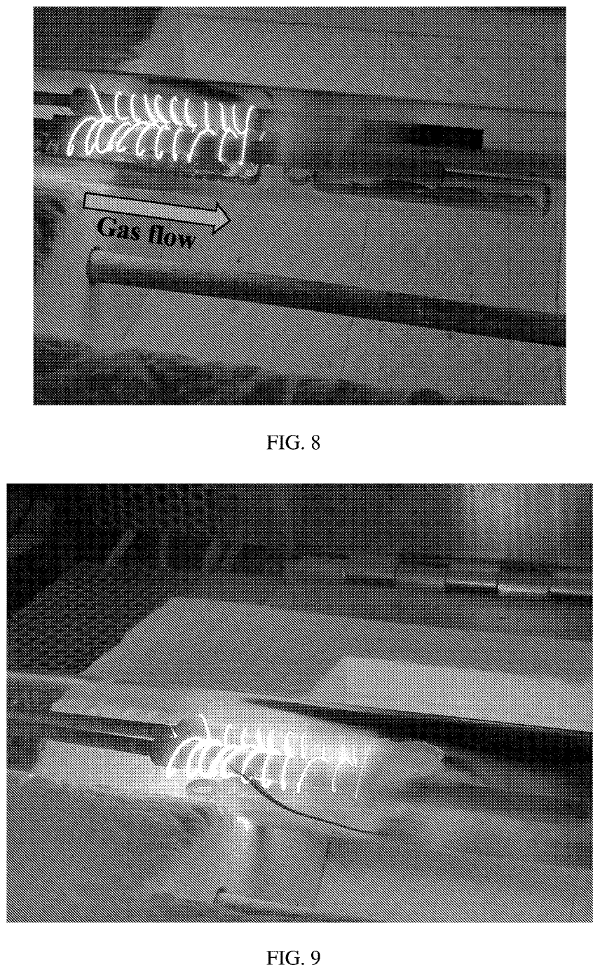

Pyrolysis experiment was conducted with methane flow of 65 sccm at an operating pressure of 0.54 atm. Two catalyst boats containing gallium were used with one boat below the filament and one boat kept 3 cms downstream from the filament (FIG. 8). The filament voltage was set at 40V and run for 20 mins. The methane conversion is observed to be ~80%. The hydrogen observed in the outlet stream is 77.3%, while methane is observed to be 6.7%. The remaining 20% are C₂Hₓ species generated during the pyrolysis. Due to the lower flow rate and less CH₄ flow, not a lot of carbon is recovered.

TABLE 2

| Injection | H₂ percentage | CH₄ percentage |
|---|---|---|
| Feed before H₂ introduction | — | 66.5, 65.6 |
| Product stream | 77.3 | 6.7 |

### Example 3. Thermo-Catalytic Methane Pyrolysis Using Hot Filament Reactor

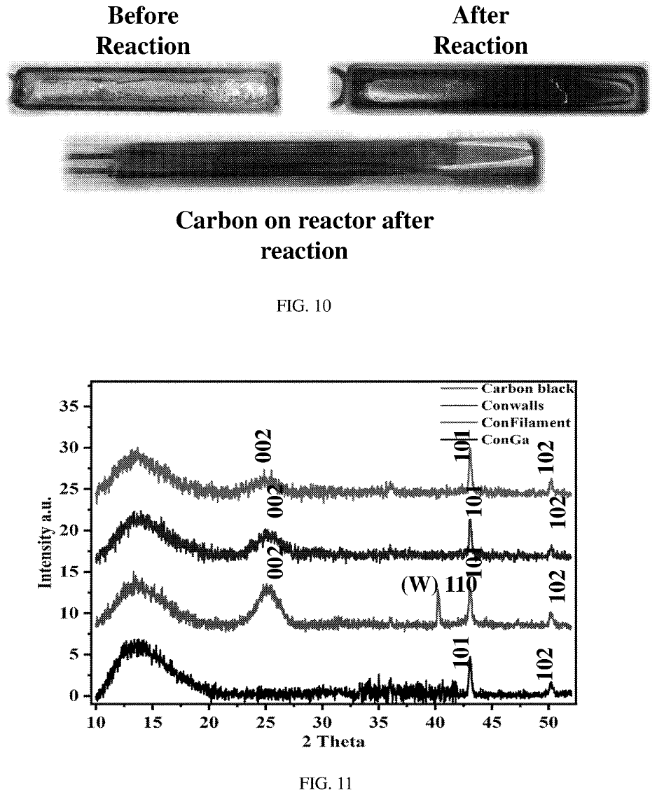

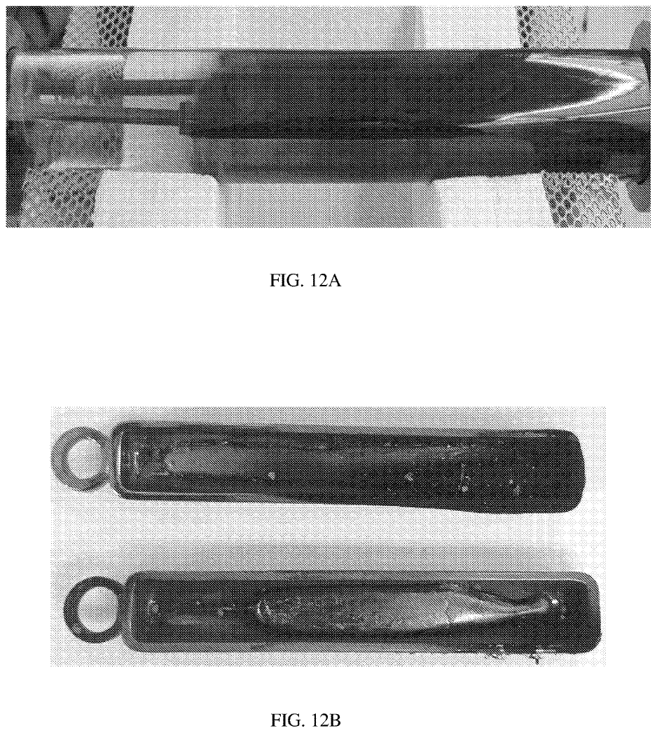

The reaction was carried out at high flow rates of methane. Pyrolysis experiment was conducted with methane flow of 540 sccm at an operating pressure of 0.66 atm. One boat was used below the filament (FIG. 9). The filament voltage was set at 40V and run for 30 mins. The methane conversion is observed to be ~46%. The gases observed in the outlet stream are H₂, CH₄, trace amounts of C₂H₂ and C₂Hₓ. Carbon deposition is seen on the boat under the filament, on the filament and also on the reactor walls (FIG. 10). The collected carbon are analysed using XRD (FIG. 11). The peak at 2⊖ of 26.7° indicate that the carbon collected has graphitic carbon in it. The carbon collected from the filament is contaminated by tungsten which is seen as a peak at 2⊖=40.2°.

### Example 4. Thermo-Catalytic Methane Pyrolysis Using Hot Filament Reactor

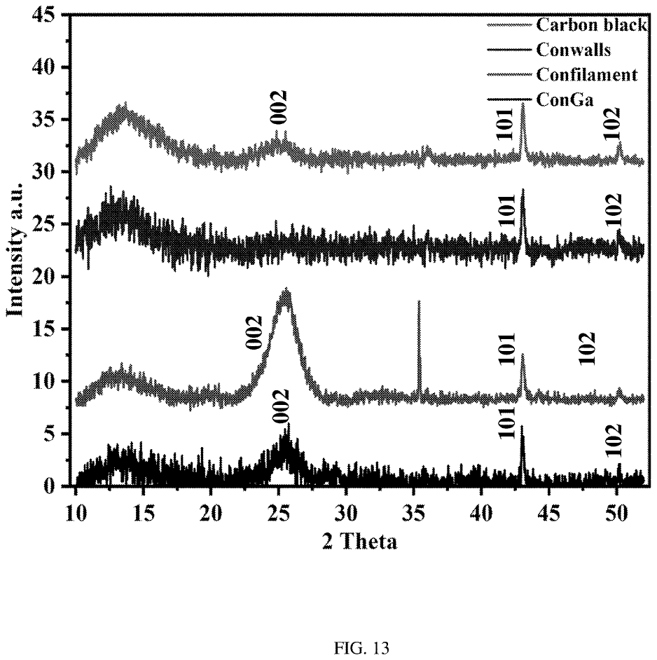

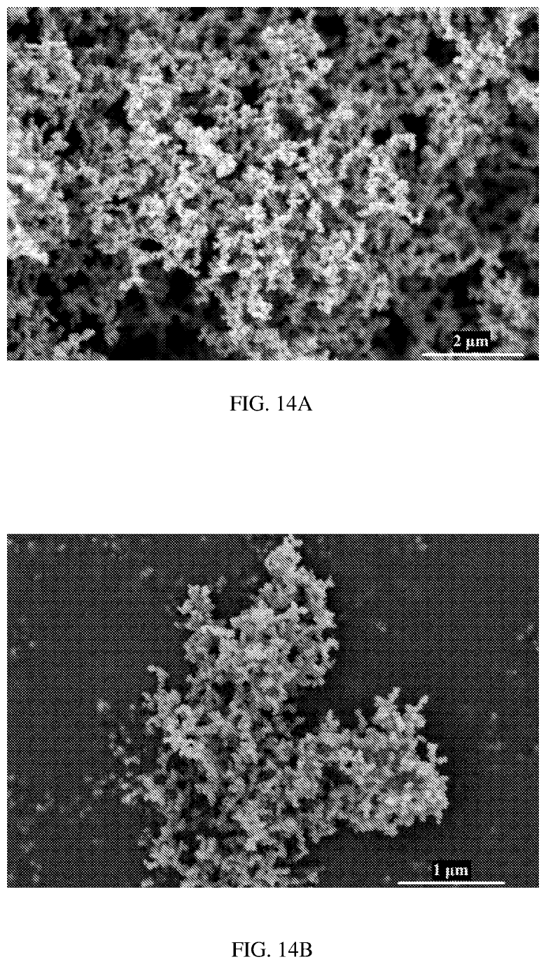

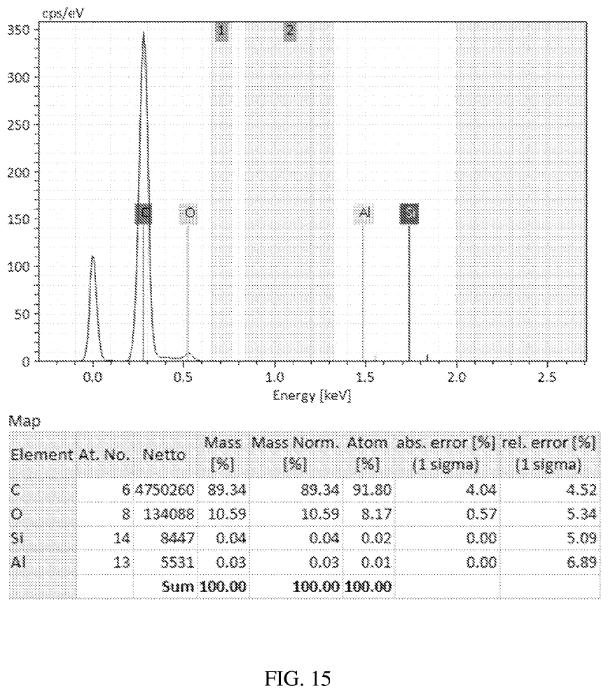

The reaction was carried out at high flow rates of methane and longer reaction time. The methane flow is set at 700 sccm at an operating pressure of 0.55 atm. Two boats of Ga were used and both were kept below the filament (FIGS. 12A-B). The filament voltage was set at 40V and run for 80 mins. The methane conversion is observed to be ~40%. The gases observed in the outlet stream are H₂, CH₄, trace amounts of C₂H₂ and C₂Hₓ. Carbon deposition is seen on the Ga in the boats under the filament, on the filament and also on the reactor walls. The carbon collected is further analysed using SEM and XRD. From the XRD data (FIG. 13) the carbon collected on the filament and the Ga substrate show graphitic peak but the one collected from the walls does not have that peak at 2⊖=26.7°. The carbon collected from the tungsten filament also shows a peak at 2⊖ of 35.2° which is an indication of WC alloy formation which would have formed due to the long reaction time. From the SEM images both carbons seem to have similar structure and the elemental analysis of the carbon sample collected from the walls indicate only carbon as the major component with trace amounts of Al and Si (FIGS. 14A-B and FIG. 15). The O observed in the analysis is very less which might be due to the atmospheric oxygen or adsorbed oxygen on the surface.

### Example 5. Thermo-Catalytic Methane Pyrolysis Using Hot Filament Reactor

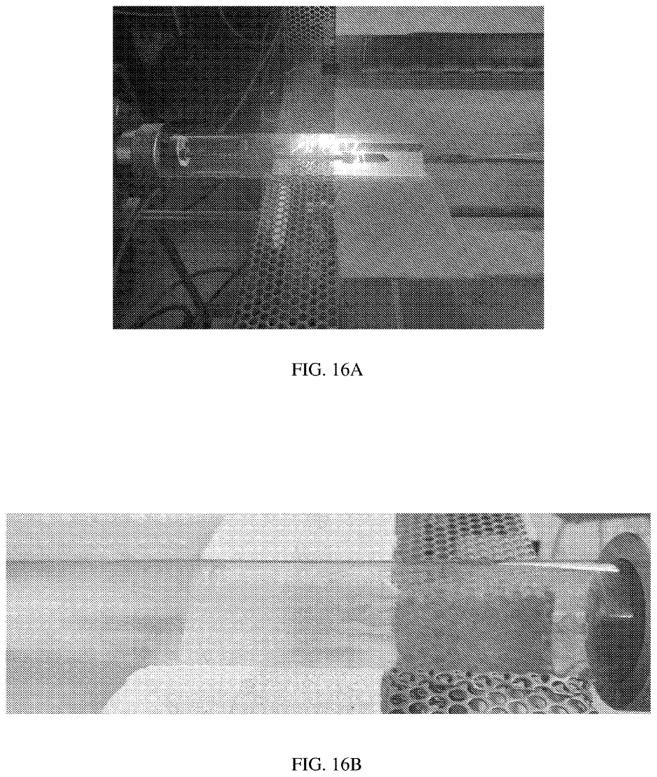

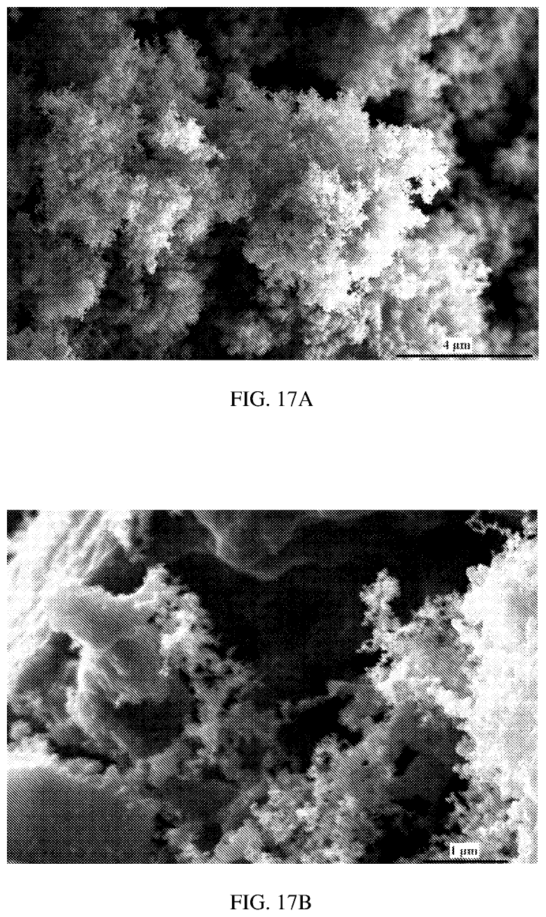

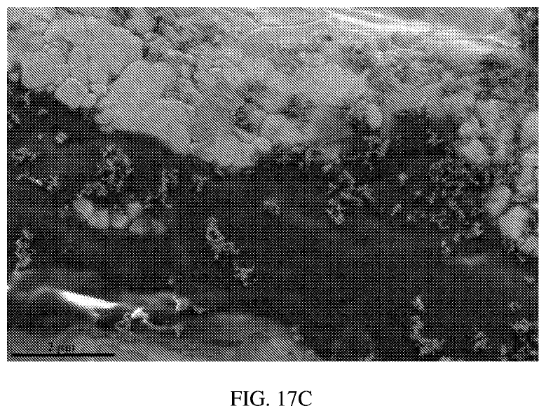

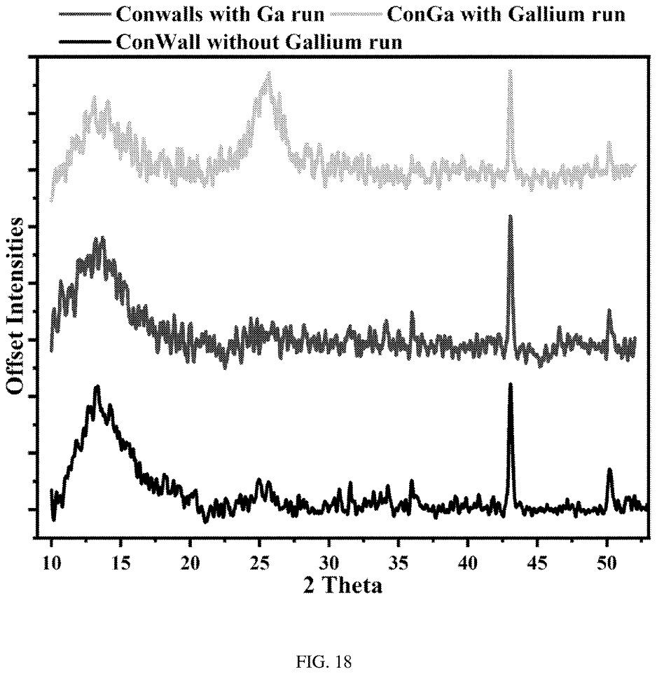

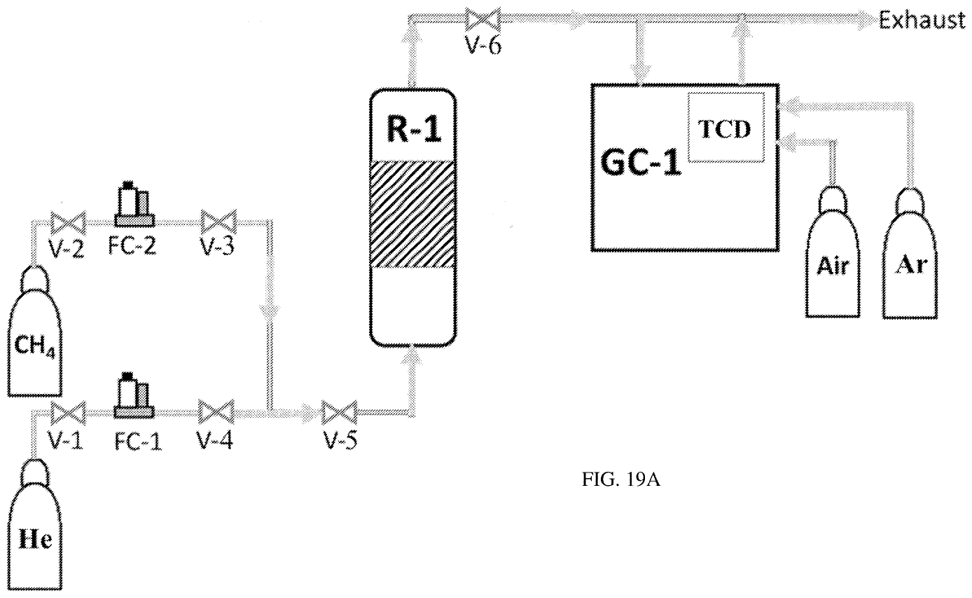

Reaction was carried out at high flow rates of methane without any catalyst. The methane flow is set at 540 sccm at an operating pressure of 0.55 atm. No Ga was used and both boats were kept below the filament (FIG. 16A). The filament voltage was set at 30V and run for 40 mins. The methane conversion is observed to be ~40%. The gases observed in the outlet stream are H₂, CH₄, trace amounts of C₂H₂ and C₂Hₓ. Carbon deposition is seen on the reactor walls and a waxy deposition is observed at the end of the reactor (FIG. 16B). The carbon collected and the tungsten filament used are analysed using SEM and XRD. The SEM images (FIGS. 17A-B) show fibrous morphology for the carbon and the W filament after reaction (FIG. 17C) shows carbon on the surface of the filament. The contrast in the image indicated carburization of the filament to form WC. The XRD data shows a comparison between the carbon collected with Ga as in Example 4 and without gallium as in the present Example (FIG. 18). The carbon collected on the Ga substrate as in Example 4 shows graphitic peak but the one collected from the walls in both cases do not have any peak at 2⊖=26.70 corresponding to graphite.

Table 3 shows the outlet gas composition for the reactions with and without Gallium. The conversions observed for methane are similar in both gases but the hydrogen concentration for the reaction with Ga is far greater than that for the run without Ga. This can be seen in the increase in concentration of acetylene in the outlet stream for the reaction without Ga.

TABLE 3
Outlet gas stream and amount of carbon estimated and collected
after the reaction for Example 4 and Example 5.

| | H₂ | C₂H₂ | Unknown | Conver- | C yield (g) |
|---|---|---|---|---|---|
| | percent- | percent- | (8.82 | sion | estimated/ |
| Injection | age | age | min) | (%) | collected |
| Product | 71.48 | 0.70 | 695 | 40 | 8.663/0.295 (ga) |
| stream | | | | | |
| from | | | | | |
| Example | | | | | |
| 4 with | | | | | |
| Gallium | | | | | |
| Product | 56.08 | 1.4 | 633.42 | 39.82 | 2.308/0.259 (walls) |
| stream | | | | | |
| from | | | | | |
| Example | | | | | |
| 5 without | | | | | |
| Gallium | | | | | |

### Example 6. Plasma-Catalytic Methane Pyrolysis for Hydrogen and Valuable Carbons

### Summary

This Example describes a plasma-catalytic approach for activating methane and pyrolyzing using molten metal-based alloys that include Gallium. Here, experiments were performed using pure methane, acetylene suggests a potential pathway for complete pyrolysis through recycle to produce hydrogen and carbons. The carbons produced are high surface area and also do not contain any impurities. The majority of the carbons produced contain graphene sheets in random manner along with onion morphologies.

The mechanism of methane pyrolysis involves a similar mechanism as that of silicon dissolution from silanes into molten Gallium. The activated species dissolve into molten Ga and then undergo dehydrogenation reactions resulting in carbon nucleation and growth on molten Ga surface. The immiscibility of carbon and molten Ga allows for easier separation of resulting carbons through simple scraping from the surface.

### Experimental

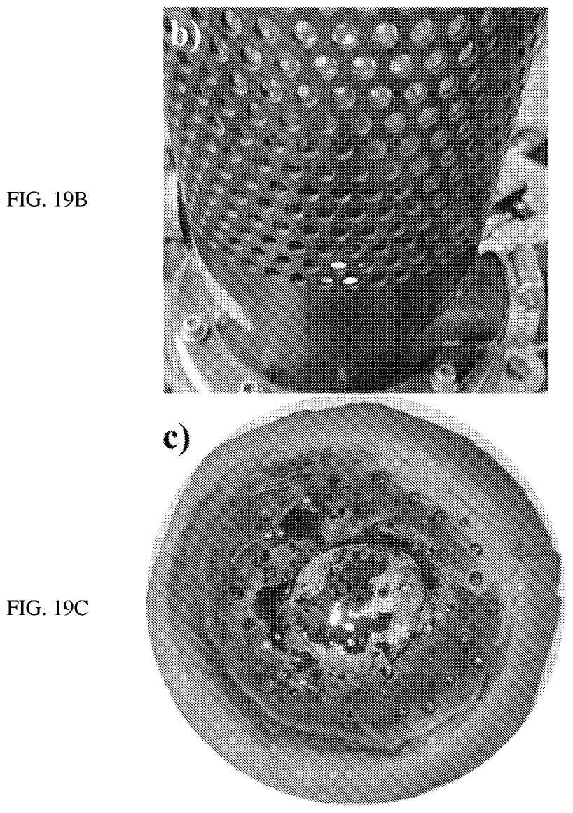

Methane pyrolysis experiments were initially conducted in a Microwave CVD ASTeX® 5010 reactor. The microwave power for plasma is varied between 300-500 W and the methane flow rate was varied between 10-100 sccm in the pressure range of 15-50 torr. A graphite substrate is used for holding the metal catalyst. It is loaded into the reactor and for alloyed catalysts the alloying of metals is done in-situ prior to the reaction in hydrogen plasma. The schematic of the reactor setup is given in FIGS. 19A-C. The substrate temperature can reach as high as 950° C. under these conditions. The exhaust gas from the reactor is analysed using online gas chromatography using Agilent 7820A instrument equipped with a thermal conductivity detector (TCD) and a Shin Carbon ST micro packed column (100/120 mesh, 2 m, 1/16 in. OD, 1.0 mm ID). The crystallinity and phase of the solid carbon collected after the reaction is analysed by X-ray diffraction (HR XRD Bruker D8 Discover diffractometer) and the morphology is analysed using SEM (FEI Nova® 600 & Thermo Fisher Apreo® C LoVac).

### Results

The methane conversion and carbon yield were calculated as follows;

$${CH}_{4} conversion = \frac{mole of methane consumed}{m oles of methane in feed} \times 100$$

$$Carbon yield = \frac{moles of carbon}{moles of {CH}_{4} consumed} \times 100$$

From the conversion data it can be seen that using microwave plasma, methane is consumed with or without catalyst. Without any catalyst the CH₄ conversion is 75% while with only Ga it increased to >90%.

Methane conversion in plasma excitation undergoes several hydrogen abstraction reactions as given below.

$${CH}_{4} + H \to {CH}_{3} + {H}_{2}$$

$${CH}_{3} + {CH}_{3} + M \to {C}_{2} {H}_{6} + M$$

$${C}_{2} {H}_{6} + H \to {C}_{2} {H}_{5} + {H}_{2}$$

$${C}_{2} {H}_{4} + H \to {C}_{2} {H}_{4} + {H}_{2}$$

$${C}_{2} {H}_{4} . + H \to {C}_{2} {H}_{3} + {H}_{2}$$

$${C}_{2} {H}_{3} + H . \to {C}_{2} {H}_{2} + {H}_{2}$$

Under pure plasma excitation, methane undergoes a series of hydrogen abstraction and recombination reactions to produce C₂H₂ and H₂ with the overall reaction as below.

$$2 {CH}_{4} \to {C}_{2} {H}_{2} + 4 {H}_{2}$$

The above overall reaction could proceed at high conversions in plasma excitation^{4, 14}. Acetylene tends to be the most stable molecule in plasmas containing hydrocarbons. It is possible to process or directly convert methane into hydrogen rich hydrocarbon streams without using any catalysts. One will need to find a way to utilize acetylene and/or unconverted methane to sequester carbon to reduce the overall carbon footprint for the resulting hydrogen. Carbon deposition occurs but mostly on walls in the form of soot. The deposition happens in the beginning stages and decreases with duration. The majority of these carbon deposits are not recoverable and useful.

The experiments using Ga—Sn and Ga—Ni as catalysts in the presence of plasma excitation using MW plasma reactor exhibited higher methane conversion of 88%. The carbon deposition is selective to gallium or gallium with metals such as tin or nickel. Much of this carbon deposited selectively on molten alloys is easily recoverable. The yield of carbon is ~100% with Ga—Ni but the carbon obtained is not completely free of catalyst. For reactions with Ga the carbon yield is 82% and for Ga—Sn it is >90% and the obtained carbon is free of any contamination.

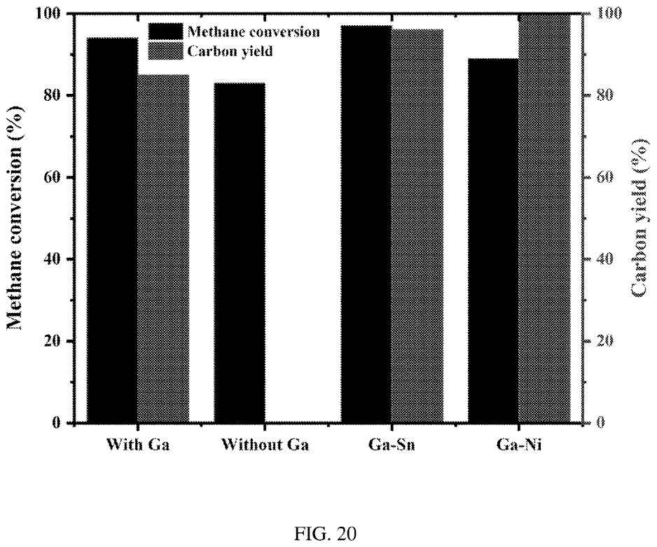

The detailed reaction parameters such as microwave power, pressure, and inlet gas flow along with the outlet gas flows of product gases such as CH₄, C₂H₂ and H₂ and the weight of carbon recovered are given in Table 4. Several experiments using methane indicate production of small amounts of C₂Hₓ species and hydrogen with pyrolysis fraction >50-60%. The resulting carbon and hydrogen balance are within +−20%. The lower amount of carbon recovered compared to that expected represents only that recovered from top of Ga surface. Other parts of the reactor could have had trace amounts of Ga that were not accessible. The maximum inlet flow that could be used was restricted to 150 sccm which was the maximum operable flow rate for the connected MFCs. Furthermore, the differences in the conversions with change in CH₄ flowrate is due to the design restrictions of the reactor. The inlet and outlet gas streams are very close which reduces the contact time between the catalyst and the excited species. Conversion data for methane and carbon yields using Ga and Ga-M (M-Sn, Ni) are given in FIG. 20.

TABLE 4
Reaction conditions and product outlet for the reactions using pure methane as feed

| | | | | | | | | H2 outlet flow | Carbon |
|---|---|---|---|---|---|---|---|---|---|
| | | | | | | Methane | Acetylene | (SCCM) (from | weight |
| | Power | Pressure | Flow | Outlet flow, | Conversion, | outlet flow | outlet flow | total outlet | recovered |
| Experiment | (W) | (Torr) | (ml/min) | ml/min | % | (SCCM) | (SSCM) | flow) | (mg) |
| With Gallium Pure Methane at | 400 | 20 | 20 | 30.16 | 94.17 | | | | |
| 20 SCCM, 20 torr | | | | | | | | | |
| With Gallium Pure Methane at | 400 | 20 | 50 | 86.5 | 83.5 | | | | |
| 50 SCCM, 20 torr | | | | | | | | | |
| With Gallium Pure Methane at | 400 | 20 | 100 | 153.21 | 85.03 | 14.97 | 29.77 | 108.47 | 891 |
| 100 SCCM, 20 torr | | | | | | | | | |
| With Gallium Pure Methane at | 400 | 20 | 150 | 239.61 | 88.5 | | | | |
| 150 SCCM, 20 torr | | | | | | | | | |
| Without Gallium Pure Methane at | 400 | 20 | 150 | 277.26 | 85 | | | | |
| 150 SCCM, 20 torr | | | | | | | | | |
| With Gallium Pure Methane at | 400 | 100 | 150 | 241.35 | 81 | 28.5 | 35.56 | 177.29 | 916 |
| 150 SCCM, 100 torr | | | | | | | | | |
| With Gallium Pure Methane at | 300 | 45 | 150 | 286.8 | 77 | 34.5 | 49.85 | 202.45 | 487 |
| 150 SCCM, 45 torr | | | | | | | | | |
| With Gallium at 100 SCCM CH₄ & | 400 | 31.5 | 100 | 176.78 | 85 | 13.66 | 11.16 | 141.96 | 2532 |
| 10 SCCM N₂ | | | | | | | | | |
| With Gallium Pure Methane at 100 | 400 | 28.2 | 100 | 167.22 | 72 | 28.00 | 29.3537 | 109.87 | 493 |
| SCCM and 20 torr new substrate | | | | | | | | | |
| With Gallium Pure Methane at 20 | 400 | 20 | 20 | 36.81 | 86.39 | 2.72 | 6.53 | 27.56 | 882 |
| sccm 10 torr for 5 hr | | | | | | | | | |

Reaction parameters and the product composition for reactions using pure acetylene as feed gas are given in Table 5. Experiments were conducted using pure acetylene to understand whether pyrolysis occurs with acetylene species interactions with molten Ga and its alloys. The results with acetylene indicate higher pyrolysis with the majority getting converted to carbon and hydrogen. The experimental results using pure acetylene indicate 95.8% conversion. These experiments indicate that acetylene species in addition to methyl species and other hydrocarbon species participate in pyrolysis reaction.

TABLE 5
Reaction conditions and product outlet for the reactions using pure acetylene as feed

| | | | | | | Methane | Acetylene | H2 outlet flow | Carbon |
|---|---|---|---|---|---|---|---|---|---|
| | | | | | | outlet | outlet | (SCCM) | weight |
| | Power | Pressure | Flow | Outlet flow, | Conversion, | flow | flow | (from total | recovered |
| Experiment | (W) | (Torr) | (ml/min) | ml/min | % | (SCCM) | (SSCM) | outlet flow) | (mg) |
| With pure Acetylene at | 400 | 20 | 50 | 58.8 | 95.83 | NA | 2.085 | 56.72 | 1932 |
| 50 SCCM, 20 torr | | | | | | | | | |
| With mixture of Acetylene, | 400 | 20 | 16.4 | 157.39 | 66 | | | | |
| Methane and hydrogen, 20 torr | | | | | | | | | |

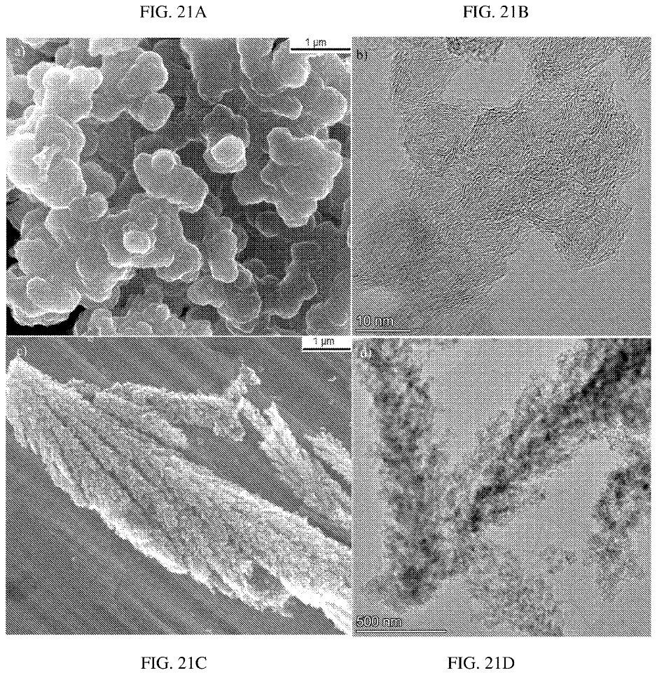

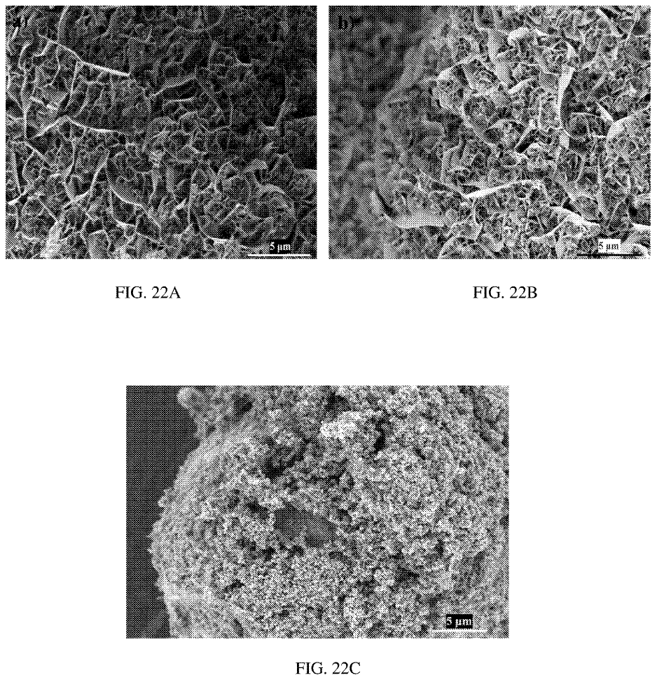

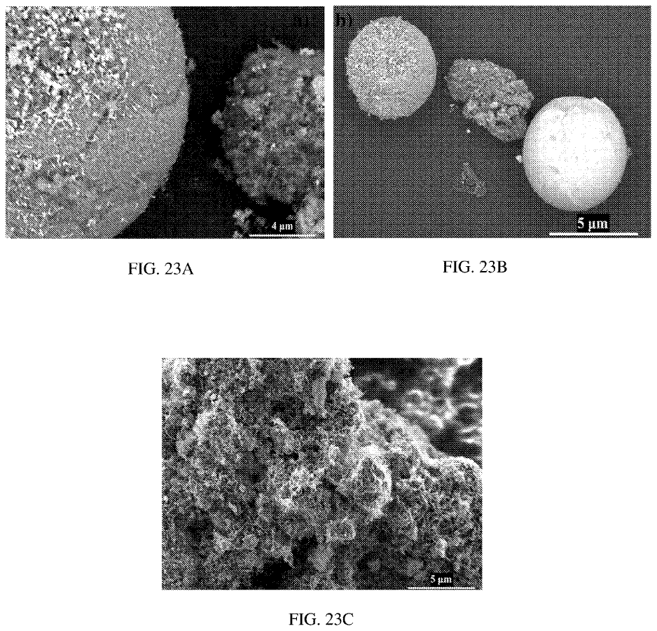

FIGS. 21A-D show the SEM and TEM images of carbon collected with Ga and the soot scraped from the walls without Ga. The carbon with Ga has onion ring like structure while the soot collected is amorphous. FIG. 22 shows the SEM images of carbon collected from the surface of Ga and Sn after the reaction with Ga and Sn as catalyst. The carbon collected from the Ga surface (FIG. 22A-B) shows walled structure with no contamination of Ga while the carbon collected from the Sn surface (FIG. 22C) does not show any structural growth. The SEM images of carbons collected after the reaction using Ga—Ni as catalyst are shown in FIGS. 23A-C. The carbon could not be completely separated from the catalyst as can be seen in FIG. 23A-B. The bright spots on the surface indicate the presence of metal (Ni). The zoomed in image shows the structure of the carbon to be whiskers which is the typical carbon deposition expected on Ni surface.

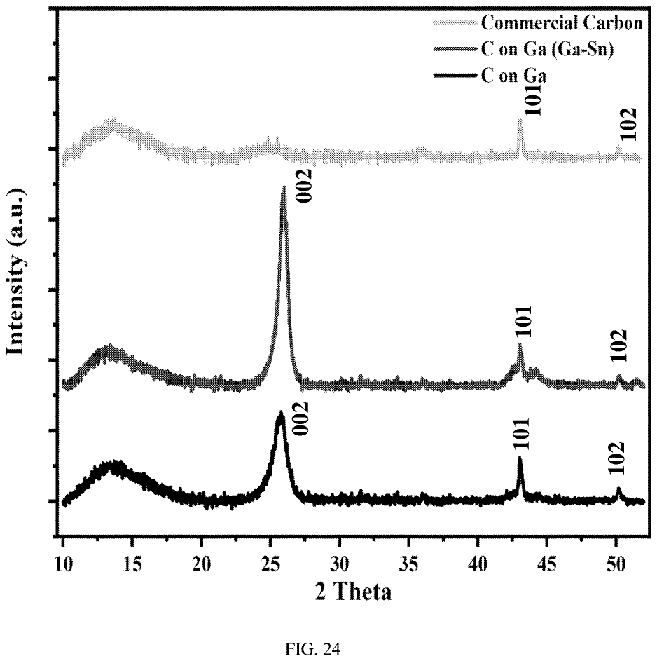

The XRD of the carbon samples collected from the reactions and commercial carbon black is given in FIG. 24. From the XRD it can be seen that the carbons obtained after MW pyrolysis of CH₄ using Ga and Ga—Sn as catalyst show high crystallinity and have higher graphitic content as can be seen from the intensity of the peak at 2⊖ of 26.7.

Plasma can be created via exciting gas phase molecules with an applied electric field through ionization and electron-molecule reactions. The energized neutral or charged species can directly impact the catalytic process by significantly decreasing the energetic barrier, or by changing the reaction pathway, eventually enhancing the rate of reaction.

### CONCLUSION

Microwave plasma has shown to be an effective way for pyrolysis of methane at low pressures with conversions of methane close to 80% without any catalyst which further improved to >90% with introduction of Ga and Ga—Sn as catalysts. The recoverable carbon yield is 82% for reaction using Ga as catalyst while it is >90% for Ga—Sn catalyst. All the recovered carbons from the reactions using catalyst showed crystalline structures as seen in the SEM and TEM analysis and are also free of any catalyst material. The carbons also have graphitic peak in the XRD analysis at 2⊖ of 26.7. The as synthesized carbons have higher intensity graphitic peaks compared to commercially available carbon black.

### REFERENCES

[1] J. M. Ogden, Prospects for building a hydrogen energy infrastructure, Annual Review of Energy and the Environment, 24 (1999) 227-279.
[2] D. Pakahare, J. Spivey, A review of dry (CO2) reforming of methane over noble metal catalysts, Chemical Society Reviews, 43 (2014) 7813-7837.
[3] J. Sentek, K. Krawczyk, M. Młotek, M. Kalczewska, T. Kroker, T. Kolb, A. Schenk, K.-H. Gericke, K. Schmidt-Szałowski, Plasma-catalytic methane conversion with carbon dioxide in dielectric barrier discharges, Applied Catalysis B: Environmental, 94 (2010) 19-26.
[4] N. Sánchez-Bastardo, R. Schlögl, H. Ruland, Methane Pyrolysis for CO2-Free H2 Production: A Green Process to Overcome Renewable Energies Unsteadiness, Chemie Ingenieur Technik, 92 (2020) 1596-1609.
[5] C.-J. Chen, M. Back, R. Back, The thermal decomposition of methane. II. Secondary reactions, autocatalysis and carbon formation; non-Arrhenius behaviour in the reaction of CH3 with ethane, Canadian Journal of Chemistry, 54 (1976) 3175-3184.
[6] D. C. Upham, V. Agarwal, A. Khechfe, Z. R. Snodgrass, M. J. Gordon, H. Metiu, E. W. McFarland, Catalytic molten metals for the direct conversion of methane to hydrogen and separable carbon, Science, 358 (2017) 917-921.
[7] N. Rahimi, D. Kang, J. Gelinas, A. Menon, M. J. Gordon, H. Metiu, E. W. McFarland, Solid carbon production and recovery from high temperature methane pyrolysis in bubble columns containing molten metals and molten salts, Carbon, 151 (2019) 181-191.
[8] D. Kanga, N. Rahimia, M. J. Gordona, H. Metiu, E. W. McFarland, Catalytic methane pyrolysis in molten MnCl2-KCl, Applied Catalysis B: Environmental 254 (2019) 659-666.
[9] K. A. Shah, B. A. Tali, Synthesis of carbon nanotubes by catalytic chemical vapour deposition: A review on carbon sources, catalysts and substrates, Materials Science in Semiconductor Processing, 41 (2016) 67-82.
[10] M. S. Dresselhaus, G. Dresselhaus, P. Avouris, Carbon Nanotubes Synthesis, Structure, Properties, and Applications, Springer, Berlin, 2001.
[11] S. Iijima, Helical microtubules of graphitic carbon, nature, 354 (1991) 56.
[12] E. C. Neyts, K. Ostrikov, M. K. Sunkara, A. Bogaerts, Plasma catalysis: synergistic effects at the nanoscale, Chemical reviews, 115 (2015) 13408-13446.
[13] G. Bhimarasetti, M. K. Sunkara, U. M. Graham, B. H. Davis, C. Suh, K. Rajan, Morphological Control of Tapered and Multi-Junctioned Carbon Tubular Structures, Advanced Materials, 15 (2003) 1629-1632.
[14] G. Bhimarasetti, J. M. Cowley, M. K. Sunkara, Carbon microtubes: tuning internal diameters and conical angles, Nanotechnology, 16 (2005) S362.
[15] M. L. Carreon, D. F. Jaramillo-Cabanzo, I. Chaudhuri, M. Menon, M. K. Sunkara, Synergistic interactions of H2 and N2 with molten gallium in the presence of plasma, Journal of Vacuum Science & Technology A: Vacuum, Surfaces, and Films, 36 (2018) 021303.
[16] D. Jaramillo, H. Paxton, M. Sunkara, Liquid Phase Epitaxial Growth of Gallium Nitride with Interrupted Plasma Nitridation of Molten Ga, Submitted (2019).
[17] P. Meduri, J. H. Kim, H. B. Russell, J. Jasinski, G. U. Sumanasekera, M. K. Sunkara, Thin-walled carbon microtubes as high-capacity and high-rate anodes in lithium-ion batteries, The Journal of Physical Chemistry C, 114 (2010) 10621-10627.

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A method for producing hydrogen, comprising:
activating a hydrocarbon to produce methyl cations and hydrogen anions in a gas phase;
forming hydrogen from the hydrogen anions in the gas phase; and
forming carbon species from the methyl cations in the gas phase, wherein forming hydrogen and carbon species is performed in a presence of a molten metal or molten metal alloy.

2. The method of claim 1, wherein the hydrocarbon is selected from the group consisting of methane, acetylene, and propane.

3. The method of claim 1, wherein the hydrocarbon is methane.

4. The method of claim 1, wherein the molten metal is gallium.

5. The method of claim 1, wherein the molten metal is selected from indium, tin, aluminum, and bismuth.

6. The method of claim 1, wherein forming hydrogen and carbon species is performed at less than 900° C.

7. The method of claim 1, wherein the molten metal alloy comprises one or more of iron, nickel, molybdenum, cobalt, ruthenium, platinum, iridium, and rhenium.

8. The method of claim 1, wherein the carbon species is a graphitic carbon.

9. The method of claim 1, wherein activating is performed by thermo-catalytic activation.

10. The method of claim 9, wherein the thermo-catalytic activation comprises
carburizing one or more filaments comprised of tungsten, rhenium, iron, or nickel or alloys thereof with the hydrocarbon;
producing the methyl cations and hydrogen anions from the one or more filaments; and
interacting the methyl cations and hydrogen anions with a surface of the molten metal or molten metal alloy, wherein the molten metal is gallium.

11. The method of claim 10, further comprising periodically removing carbon species formed on the surface.

12. The method of claim 1, wherein activating is performed by a plasma catalytic activation.

13. The method of claim 12, wherein the plasma catalytic activation comprises
forming a plasma containing electrons, wherein the electrons collide with the hydrocarbon to produce the methyl cations and the hydrogen anions; and
passing droplets or particles of the molten metal or molten metal alloy through the plasma, wherein the molten metal is gallium.

14. An integrated device for production of hydrogen, comprising:
a hydrocarbon inlet;
an excitation source configured to heat the hydrocarbon flowing in the hydrocarbon inlet to produce methyl cations and hydrogen anions;
a reservoir for containing a molten metal or molten metal alloy, wherein the reservoir is positioned adjacent the excitation source such that hydrogen is formed from the hydrogen anions and carbon species is formed from the methyl cations while in a gas phase adjacent a surface of the molten metal or molten metal alloy;
a collection space for collecting the carbon species; and
an outlet for collecting the hydrogen.

15. The integrated device of claim 14, wherein the excitation source is a filament grid.

16. The integrated device of claim 14, wherein the excitation source is a plasma containing electrons.
